(19) United States
(12) Patent Application Publication
(10) Pub. No.: US 2024/0112085 A1
(43) Pub. Date: Apr. 4, 2024

(54) METHODS AND SYSTEMS FOR ESTIMATING AND EVALUATING MODEL PERFORMANCE IN PRODUCTION

(71) Applicant: Tata Consultancy Services Limited, Mumbai (IN)

(72) Inventors: NIRBAN BOSE, Bangalore (IN); AMIT KALELE, Pune (IN); JAYASHREE ARUNKUMAR, Chennai (IN)

(73) Assignee: Tata Consultancy Services Limited, Mumbai (IN)

(21) Appl. No.: 18/453,100

(22) Filed: Aug. 21, 2023

(30) Foreign Application Priority Data
Sep. 22, 2022 (IN) 202221054354

(51) Int. Cl. G06N 20/00

(52) U.S. Cl. CPC G06N 20/00

(57) ABSTRACT

Performance of a machine learning (ML) model in production, is heavily dependent on underlying distribution of data or underlying process generating labels from attributes. Any change in either one or both impacts the ML model performance heavily and inhibits knowledge of true labels. This in turn affects ML model uncertainty. Thus, performance monitoring of ML models in production becomes necessary. Embodiments of the present disclosure provide estimates operating model accuracy at production stage by constructing the correlations between the model accuracy, model uncertainty and deviation of the distributions in absence of ground truth. In the method of present disclosure, the model performance of the machine learning (ML) model deployed in production is estimated in absence of ground truths. Moreover, this can be done without retraining the model, thus saving computational costs and resources. The method of the present disclosure can be used and performed in real time.

### PRIORITY CLAIM

This U.S. patent application claims priority under 35 U.S.C. § 119 to: India Application No. 202221054354, filed on Sep. 22, 2022. The entire contents of the aforementioned application are incorporated herein by reference.

### TECHNICAL FIELD

The disclosure herein generally relates to the field of artificial intelligence, and, more particularly, to methods and systems for estimating and evaluating model performance in production.

### BACKGROUND

With evolution of technology, there is a surge in use of artificial intelligence (AI) in varying applications of multiple industries. Artificial intelligence applications are enabled to solve problems by developing and deploying machine learning models. An AI/ML model is often sensitive to changes in underlying data distribution or underlying process. When the ML model is deployed in production, perturbations can affect performance of ML model. This might further affect stability of the ML model and retraining the ML model becomes inevitable in several scenarios. Thus, the performance of ML models in production can be significantly impacted if the underlying distribution of the data or the underlying process changes. This in turn can significantly impact business decisions. Thus, performance monitoring of ML models in production becomes necessary. Conventional methods for ML model performance monitoring involve estimating drift in new production data with respect to some reference data. However, the conventional methods fail to monitor the ML model performance in varying scenarios.

### SUMMARY

Embodiments of the present disclosure present technological improvements as solutions to one or more of the above-mentioned technical problems recognized by the inventors in conventional systems. For example, in one embodiment, a processor implemented method is provided. The method comprising receiving, via one or more hardware processors, a plurality of test data Dₜₑₛₜ and a model under evaluation M as an input from a user; computing, via the one or more hardware processors, a drift distribution of the plurality of test data Dₜₑₛₜ using one or more user specified drift computation methods; comparing, via the one or more hardware processors, a spread in the computed drift distribution of the plurality of test data Dₜₑₛₜ with a predefined threshold; performing, via the one or more hardware processors, steps (i) through (iii) when the spread in the computed drift distribution of the plurality of test data Dₜₑₛₜ exceeds the predefined threshold: (i) partitioning, the plurality of test data Dₜₑₛₜ into a first dataset and a second dataset, wherein the second dataset is divided into a plurality of data buckets, (ii) determining, a first set of model parameters for a plurality of data samples comprised in each data bucket from the plurality of data buckets with respect to the first dataset, wherein the first set of model parameters includes a drift distance, a model uncertainty, and one or more model performance metrics, and (iii) constructing, a first look up table by identifying a correlation among a plurality of model parameters in the first set of model parameters; computing, via the one or more hardware processors, a drift distribution of a plurality of incoming test data received from the user; identifying, via the one or more hardware processors, a drift value cell from the first look up table, corresponding to the computed drift distribution of the plurality of incoming test data, wherein the drift value cell is identified based on (i) a minimum deviation between the computed drift distribution of the plurality of incoming test data and a plurality of pre-stored drift distance values in the first look up table, and (ii) a minimum value of model uncertainty; and estimating, via the one or more hardware processors, at least one of the one or more model performance metrics corresponding to the identified drift value cell from the first look up table to evaluate an optimal performance of the model under evaluation M.

In another aspect, a system is provided. The system comprising a memory storing instructions; one or more communication interfaces; and one or more hardware processors coupled to the memory via the one or more communication interfaces, wherein the one or more hardware processors are configured by the instructions to receive, a plurality of test data Dₜₑₛₜ and a model under evaluation M as an input from a user; compute, a drift distribution of the plurality of test data Dₜₑₛₜ using one or more user specified drift computation methods; compare, a spread in the computed drift distribution of the plurality of test data Dₜₑₛₜ with a predefined threshold; perform, steps (i) through (iii) when the spread in the computed drift distribution of the plurality of test data Dₜₑₛₜ exceeds the predefined threshold: (i) partitioning, the plurality of test data Dₜₑₛₜ into a first dataset and a second dataset, wherein the second dataset is divided into a plurality of data buckets, (ii) determining, a first set of model parameters for a plurality of data samples comprised in each data bucket from the plurality of data buckets with respect to the first dataset, wherein the first set of model parameters includes a drift distance, a model uncertainty, and one or more model performance metrics, and (iii) constructing, a first look up table by identifying a correlation among a plurality of model parameters in the first set of model parameters; compute, a drift distribution of a plurality of incoming test data received from the user; identify, a drift value cell from the first look up table, corresponding to the computed drift distribution of the plurality of incoming test data, wherein the drift value cell is identified based on (i) a minimum deviation between the computed drift distribution of the plurality of incoming test data and a plurality of pre-stored drift distance values in the first look up table, and (ii) a minimum value of model uncertainty; and estimate, at least one of the one or more model performance metrics corresponding to the identified drift value cell from the first look up table to evaluate an optimal performance of the model under evaluation M.

In yet another aspect, a non-transitory computer readable medium is provided. The non-transitory computer readable medium comprising receiving, a plurality of test data Dₜₑₛₜ and a model under evaluation M as an input from a user; computing, a drift distribution of the plurality of test data Dₜₑₛₜ using one or more user specified drift computation methods; comparing, a spread in the computed drift distribution of the plurality of test data Dₜₑₛₜ with a predefined threshold; performing, steps (i) through (iii) when the spread in the computed drift distribution of the plurality of test data Dₜₑₛₜ exceeds the predefined threshold: (i) partitioning, the plurality of test data Dₜₑₛₜ into a first dataset and a second dataset, wherein the second dataset is divided into a plurality of data buckets, (ii) determining, a first set of model parameters for a plurality of data samples comprised in each data bucket from the plurality of data buckets with respect to the first dataset, wherein the first set of model parameters includes a drift distance, a model uncertainty, and one or more model performance metrics, and (iii) constructing, a first look up table by identifying a correlation among a plurality of model parameters in the first set of model parameters; computing, a drift distribution of a plurality of incoming test data received from the user; identifying, a drift value cell from the first look up table, corresponding to the computed drift distribution of the plurality of incoming test data, wherein the drift value cell is identified based on (i) a minimum deviation between the computed drift distribution of the plurality of incoming test data and a plurality of pre-stored drift distance values in the first look up table, and (ii) a minimum value of model uncertainty; and estimating, at least one of the one or more model performance metrics corresponding to the identified drift value cell from the first look up table to evaluate an optimal performance of the model under evaluation M.

In accordance with an embodiment of the present disclosure, wherein the model under evaluation M is an artificial intelligence based model or a machine learning based model.

In accordance with an embodiment of the present disclosure, wherein the predefined threshold is configurable.

In accordance with an embodiment of the present disclosure, wherein the one or more model performance metrics comprises of an accuracy, an F1 score, and an average precession.

In accordance with an embodiment of the present disclosure, wherein when the spread in the drift distribution of the plurality of test data Dₜₑₛₜ is below the predefined threshold is further configured to: perturb, the second dataset to obtain a perturbed dataset using noise perturbations, wherein the noise perturbations are sampled from gaussian, uniform or poisson distributions and linearly superposed on top of a plurality of true samples of the second dataset; determine, a second set of model parameters for a plurality of data samples comprised in each data bucket from a plurality of data buckets of the perturbed dataset with respect to the first dataset, wherein the second set of model parameters include a fitted drift mean, the model uncertainty, and the one or more model performance metrics; construct, a second look up table by identifying a correlation among each of the second set of model parameters; compute, a fitted drift mean distribution of the plurality of incoming test data received from the user; identify, a drift value cell from the second look up table corresponding to the computed fitted drift mean distribution of the plurality of incoming test data, wherein the drift value cell is identified based on (i) a minimum deviation between the computed fitted drift mean distribution of the plurality of incoming test data and a plurality of pre-stored fitted drift mean values in the second look up table and (ii) a minimum value of model uncertainty; and estimate, at least one of the one or more model performance metrics corresponding to the identified drift value cell from the second look up table to evaluate an optimal performance of the model under evaluation M.

In accordance with an embodiment of the present disclosure, wherein the optimal performance of the model under evaluation M is evaluated when the model under evaluation M is deployed in production.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates an exemplary system for estimating and evaluating model performance in production, in accordance with an embodiment of the present disclosure.

FIG. 2 with reference to FIGS. 1, depicts an exemplary flow chart illustrating a method for estimating and evaluating model performance in production, in accordance with an embodiment of the present disclosure.

FIG. 3A and 3B depict graphical representations to illustrate variation of error bound with model confidence for different sample sizes, in accordance with an embodiment of the present disclosure.

FIGS. 4A and 4B depict plots illustrating correlation between drift, model performance and model uncertainty for two different type of sample data, in accordance with an embodiment of the present disclosure.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the scope of the disclosed embodiments.

Artificial intelligence is gaining momentum and is being used in many industries for multiple applications. Artificial intelligence applications are enabled to solve problems by developing and deploying machine learning models. After model assurance stage, when an ML model is deployed in production, its performance decays over a period of time due to varying factors. One of the most common factors for this shift in the distributions of the input attribute space or change in the underlying process that generates the outputs, is a process known as drift. This drift in the data impacts ML model sustainability by inhibiting a knowledge of true labels and also affecting ML model uncertainty. This in turn can significantly impact ML model's decision making thereby affecting business decision. Thus, it is important to monitor the deployed model at the production stage. The most common strategy that arises out of production monitoring is retraining the ML model as soon as there is a significant degradation in the ML model performance. But retraining is computationally and resourcefully extensive. Further, few conventional methods for ML model performance monitoring involve estimating drift in new production data with respect to some reference data. However, the conventional methods fail to monitor the ML model performance in varying scenarios. One such scenario is impact of the drift in absence of ground truths on the ML model performance. Two relevant quantities of interest for ML model performance monitoring are the drift and the model uncertainty. These two quantities are usually treated on a different footing by data scientists and AI/ML practitioners. The present disclosure tries to treat the drift and the model uncertainty on same footing and investigate their correlation with the model performance. In the present disclosure, the correlation between these quantities is exploited and model performance is computed for a given drift thus avoiding the retraining part unless necessary.

In other words, the performance of a machine learning (ML) model in production is heavily dependent on underlying distribution of data or underlying process generating labels from attributes. Any change in either one or both impacts the ML model performance heavily and inhibits knowledge of true labels. This in turn affects ML model uncertainty. Thus, performance monitoring of ML models in production becomes necessary.

Embodiments of the present disclosure provide methods and systems for estimating and evaluating model performance in production. The method of the present disclosure estimates operating model accuracy at production stage by constructing the correlations between the model accuracy, model uncertainty and deviation of the distributions. More Specifically, the present disclosure describes the following:
1. An automated framework for constructing the drift, model uncertainty, and model performance correlation from a user supplied test data and model.
2. An automated algorithm for consuming the user supplied test data having a different underlying distribution and evaluating the model performance from the correlation table and raising triggers if the model performance is significantly off.
3. A generic mathematical framework and empirical approach to estimate variation of upper bound on deviation between predicted and ground truth with model confidence.

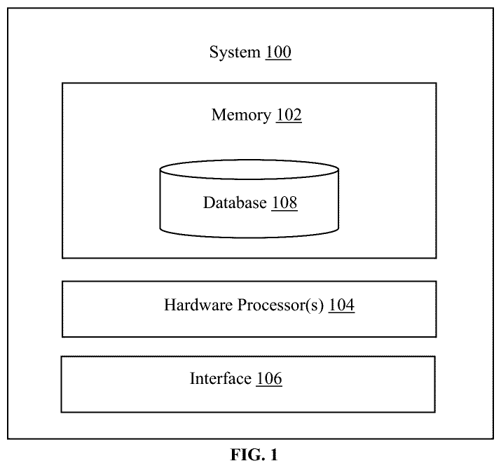

Referring now to the drawings, and more particularly to FIGS. 1 through 4B, where similar reference characters denote corresponding features consistently throughout the figures, there are shown preferred embodiments and these embodiments are described in the context of the following exemplary system and/or method.

FIG. 1 illustrates an exemplary system 100 for estimating and evaluating model performance in production, in accordance with an embodiment of the present disclosure. In an embodiment, the system 100 includes one or more hardware processors 104, communication interface device(s) or input/output (I/O) interface(s) 106 (also referred as interface(s)), and one or more data storage devices or memory 102 operatively coupled to the one or more hardware processors 104. The one or more processors 104 may be one or more software processing components and/or hardware processors. In an embodiment, the hardware processors can be implemented as one or more microprocessors, microcomputers, microcontrollers, digital signal processors, central processing units, state machines, logic circuitries, and/or any devices that manipulate signals based on operational instructions. Among other capabilities, the processor(s) is/are configured to fetch and execute computer-readable instructions stored in the memory. In an embodiment, the system 100 can be implemented in a variety of computing systems, such as laptop computers, notebooks, hand-held devices, workstations, mainframe computers, servers, a network cloud and the like.

The I/O interface device(s) 106 can include a variety of software and hardware interfaces, for example, a web interface, a graphical user interface, and the like and can facilitate multiple communications within a wide variety of networks N/W 5 and protocol types, including wired networks, for example, LAN, cable, etc., and wireless networks, such as WLAN, cellular, or satellite. In an embodiment, the I/O interface device(s) can include one or more ports for connecting a number of devices to one another or to another server.

The memory 102 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. In an embodiment, a database 108 is comprised in the memory 102, wherein the database 108 comprises a plurality of test data received from user, one or more AI/ML models, one or more look up tables, one or more model parameters, incoming test data.

The database 108 further comprises one or more modules which when invoked and executed perform corresponding steps/actions as per the requirement by the system 100 to perform the methodologies described herein. The memory 102 further comprises (or may further comprise) information pertaining to input(s)/output(s) of each step performed by the systems and methods of the present disclosure. In other words, input(s) fed at each step and output(s) generated at each step are comprised in the memory 102 and can be utilized in further processing and analysis.

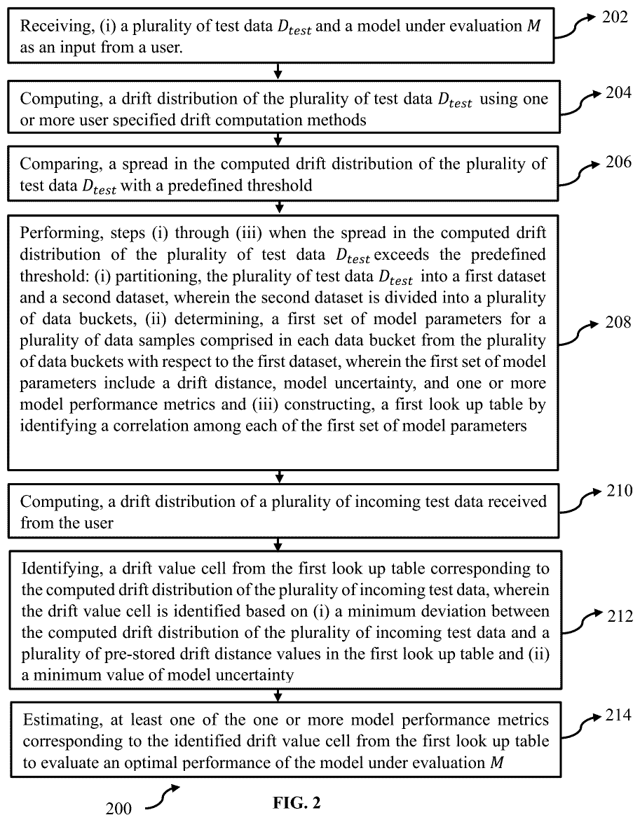

FIG. 2, with reference to FIG. 1, depicts an exemplary flow chart illustrating a method 200 for estimating and evaluating model performance in production, using the system 100 of FIG. 1, in accordance with an embodiment of the present disclosure.

Referring to FIG. 2, in an embodiment, the system(s) 100 comprises one or more data storage devices or the memory 102 operatively coupled to the one or more hardware processors 104 and is configured to store instructions for execution of steps of the method by the one or more processors 104. The steps of a method 200 in FIG. 2 of the present disclosure will now be explained with reference to components of the system 100 of FIG. 1, and the flow diagram as depicted in FIG. 2. The method of the present disclosure comprises of two phases. A first phase of the two phases involves construction of a look up table (Alternatively referred as correlation table), while a second phase details deployment in production. In an embodiment, at step 202 of the present disclosure, the one or more hardware processors 104 are configured to receive, a plurality of test data Dₜₑₛₜ and a model under evaluation M as an input from a user. In an embodiment, the plurality of test data Dₜₑₛₜ and the model under evaluation M are received through a graphical user interface. In an embodiment, the user could be a human, an externally system or device connected through network and configured to provide the input data using the graphical user interface. The plurality of test data Dₜₑₛₜ may include but not limited to a text data, an audio data, an image data, a video data, and/or the like. The plurality of test data Dₜₑₛₜ may pertain but not limited to a retail domain, a finance domain, life science domain, health care domain, manufacturing domain, and/or the like. In an embodiment, the model under evaluation M is an artificial intelligence based model or a machine learning based model. The model under evaluation M may further include but not limed to a deep learning model, a regression model, a random forest model, a XGBoost, and neural network based models such as convolutional neural network (CNN) model, recurrent neural network (RNN)based model, and/or the like. In the context of the present disclosure, expressions ‘model’ and expressions ‘machine learning (ML) model’ and ‘artificial intelligence (AI) model’ can be interchangeably used.

In an embodiment, at step 204 of the present disclosure, the one or more hardware processors 104 are configured to compute a drift distribution of the plurality of test data Dₜₑₛₜ using one or more user specified drift computation methods. The one or more user specified drift computation methods may include but not limited to Jensen-Shannon (JS) distance method, Kullback-Leibler (KL) divergence method, Maximum-Mean-Discrepancy method, and/or the like.

In an embodiment, at step 206 of the present disclosure, the one or more hardware processors 104 are configured to compare a spread in the computed drift distribution of the plurality of test data Dₜₑₛₜ with a predefined threshold. In an embodiment, the predefined threshold is configurable and specified by the user depending upon the application. The predefined threshold is denoted by δ. The spread in the computed drift distribution is indicative of a minimum to maximum value of the computed drift distribution of the plurality of test data Dₜₑₛₜ.

In an embodiment, at step 208 of the present disclosure, when the spread in the computed drift distribution of the plurality of test data Dₜₑₛₜ exceeds the predefined threshold, the one or more hardware processors 104 are configured to perform steps that includes first partitioning, the plurality of test data Dₜₑₛₜ into a first dataset and a second dataset. The first dataset is indicative of a reference dataset and denoted as x_{ref}. Size of the reference dataset x_{ref} is specified by user depending on size of the test data Dₜₑₛₜ itself. The second dataset is divided into a plurality of data buckets. The second dataset is indicative of remaining part of the test data Dₜₑₛₜ and denoted by Dₜₑₛₜ−x_{ref}. The data buckets are chosen randomly with a user defined sample size. Further, a first set of model parameters are determined for a plurality of data samples comprised in each data bucket from the plurality of data buckets with respect to the first dataset. The plurality of data samples comprised in each data bucket from the plurality of data buckets is denoted by xᵢ where i denotes the i^{th} data bucket. In an embodiment, the first set of model parameters include a drift distance, model uncertainty, and one or more model performance metrics. In an embodiment, the drift distance is determined using a compute_drift( ) module which evaluates drift of each data bucket using any user specified drift evaluating method.compute_uq( ) module which evaluates the model uncertainty of each data bucket using user specified drift evaluation method. Similarly, the one or more model performance metrics for each data bucket are determined using a compute_mperf( ) module. In an embodiment, the one or more model performance metrics comprises of an accuracy, an F1 score, and an average precession. In an embodiment, the one or more model performance metrics and an evaluation function can be supplied from user end depending on a particular case study. Furthermore, a first look up table is constructed by identifying a correlation among a plurality of model parameters in the first set of model parameters. In an embodiment, the lookup table could be interchangeably used as a correlation table in the description of the present disclosure. In an embodiment, the correlation table stores the drift distance, the model uncertainty, and the one or more model performance metrics. The correlation table is constructed only once and acts as a lookup or reference table for evaluating the ML model performance for a given drift.

However, when the spread in the drift distribution of the plurality of test data Dₜₑₛₜ is below the predefined threshold, it indicates that there is no significant drift distribution of data with respect to the reference dataset chosen from the plurality of test data Dₜₑₛₜ due to insufficient number of data samples in the second dataset. In such scenarios, the second dataset is perturbed to obtain a perturbed dataset using noise perturbations though a perturb( ) module. The noise perturbations are sampled from gaussian, uniform or poisson distributions and are linearly superposed on top of a plurality of true samples of the second dataset. Mathematically, every i^{th} point denoted by Xᵢ in the perturbed dataset D is represented as provided in equation (1) below as:

Xᵢ=αᵢ+βᵢ, i˜D (1)

Here, βᵢ denotes i^{th} noise point sampled from gaussian, uniform or poisson distributions. In an embodiment, βᵢ˜N(μ, Σ), βᵢ˜U (a, b), and βᵢ˜P (k, Δ). Here, μ represents mean and Σ represents standard deviation of the normal distribution which can be user specified depending on a use case, a and b represent upper and lower limits of the normal distribution respectively which is user defined, and k,Δ denotes user supplied poisson parameters.

Further, a second set of model parameters is determined for a plurality of data samples comprised in each data bucket from a plurality of data buckets of the perturbed dataset with respect to the first dataset. The second set of model parameters include a fitted drift mean, the model uncertainty, and the one or more model performance metrics. For perturbed data samples, the drift distance is determined using the compute_drift( ) module and determined drift distance samples are fitted with a normal distribution. The mean of the fitted normal distribution of the drift distance samples is used to parametrize the drift in a particular data bucket. In other words, the perturbed data samples in each data bucket are fitted with a normal distribution and a corresponding drift mean is obtained. So instead of drift distance, deviations in each data bucket are characterized by the mean of drift distance distribution. Further, a second look up table is constructed by identifying a correlation among each of the second set of model parameters. In an embodiment, the first look up table and second look up table are different.

In an embodiment, the performance of the model under evaluation M is evaluated when the model under evaluation M is deployed in production. Thus, after construction of the first look table or the second look up table during offline phase (i.e., first phase), the model is deployed in production which indicates initiation of an online phase (i.e., second phase).

In an embodiment, at step 210 of the present disclosure, the one or more hardware processors 104 are configured to compute a drift distribution of a plurality of incoming test data received from the user. In an embodiment, the plurality of incoming data represents new production data. In an embodiment, the drift distribution of a plurality of incoming test data is computed using the one or more user specified drift computation methods.

Further, at step 212, a drift value cell is identified from the first look up table corresponding to the computed drift distribution of the plurality of incoming test data. The drift value cell is identified based on (i) a minimum deviation between the computed drift distribution of the plurality of incoming test data and a plurality of pre-stored drift distance values in the first look up table and (ii) a minimum value of model uncertainty. Further, at step 214, at least one of the one or more model performance metrics corresponding to the identified drift value cell from the first look up table is estimated to evaluate an optimal performance of the model under evaluation M. In other words, for a user specified incoming dataset, once the drift distance is computed, a corresponding drift value cell from the first look up table (alternatively referred as correlation table) which is having minimum deviation with respect to the computed drift distance value is identified. Along with that nearest neighboring two drift value cells having subsequent higher and lower values are chosen. There can be multiple drift value cells corresponding to a single drift distance. Thus, the drift value cell corresponding to the minimum model uncertainty value is selected as that represents most stable model performance.

However, when the spread in the drift distribution of the plurality of test data Dₜₑₛₜ is below the predefined threshold, a fitted mean of drift distribution of the plurality of incoming test data is computed and the drift value cell is identified from the second look up table corresponding to the computed fitted mean of the drift distribution of the plurality of incoming test data. The drift value cell is identified based on (i) a minimum deviation between the computed fitted mean of drift distribution of the plurality of incoming test data and a plurality of pre-stored drift distance values in the first look up table and (ii) a minimum value of model uncertainty. Further, the optimal performance of the model under evaluation M is evaluated by estimating at least one of the one or more model performance metrics corresponding to the identified drift value cell from the second look up table. In an embodiment, a sample look up table for a fraud detection use case is provided in Table 1. Each row in Table 1 represents the drift distance or fitted drift mean of the distribution, model uncertainty and model performance metric values (Average precision is used as the model performance metric in Table 1). As shown in Table 1, the drift estimated for a given production point was computed to be 0.01195 and nearest neighbor or minimum deviation point with respect to the production point was 0.011935 which corresponds to multiple average precision values. Among them, the lowest model uncertainty value is 0.0189 which corresponds to a model performance of 0.793. This model performance of 0.793 stands to be most stable operating accuracy of the model.

TABLE 1

| Drift/Fitted drift | Model performance Metric | Model Uncertainty |
|---|---|---|
| mean | (Avg precision) | (UQ) |
| 0.025905 | 0.650 | 0.062 |
| 0.024873 | 0.720 | 0.081 |
| 0.024900 | 0.790 | 0.054 |
| 0.020101 | 0.720 | 0.058 |
| 0.020101 | 0.732 | 0.054 |
| 0.020101 | 0.736 | 0.051 |
| 0.019830 | 0.790 | 0.061 |
| 0.015011 | 0.789 | 0.039 |
| 0.015180 | 0.791 | 0.040 |
| 0.011935 | 0.793 | 0.018 |
| 0.011935 | 0.898 | 0.022 |
| 0.011935 | 0.799 | 0.031 |
| 0.009172 | 0.8 | 0.052 |

The entire approach/method of the present disclosure for estimating the ML model performance for a given drift using a correlation table between drift, model performance metrics and model uncertainty estimate can be further better understood by way of following pseudo code provided as example:

```
  Data: Dₜₑₛₜ ; Model: M
  Initialize: x_{ref} ∈ Dₜₑₛₜ
  Dₜₑₛₜ − x_{ref} : xᵢ → i = random(N)
  if compute_drift(xᵢ) > δ_{drift} then
    Eval_Perform( )
  else
    Perturb_Eval_Perform( )
  End
  Eval_Perform( ) :
  for i = 1 → N do
    drift = compute_drift(x_{ref},xᵢ)
    uq = compute_uq(yᵢ,predict(model,xᵢ))
    mperf = compute_mperf(xᵢ,yᵢ)
  end
  Store : Correlation Table (T : drift,uq,mperf)
  estimate_model_acc(xᵥₐₗ)
  while True do
    driftᵥₐₗ = compute_drift(x_{ref},xᵥₐₗ)
    for k in T do
          (|driftᵥₐₗ − driftₖ|)
    end
    kₘᵢₙ = k: → min(|driftᵥₐₗ − driftₖ|)
(mperf,uq)ₚ :→ p = kₘᵢₙ,kₘᵢₙ₋₁,kₘᵢₙ₊₁
    (mperf)_{best} = (mperf)ₚ :→ min(uqₚ)
    if |(mperf)_{best} − (mperf)ᵥₐₗ| > δ
      then
        return (mperf)_{best}
        Raise trigger
    end
  end
```

The method of the present disclosure for estimating the ML model performance for a given drift using a correlation table between drift, model performance metrics and model uncertainty estimate when the spread in the drift distribution of the plurality of test data Dₜₑₛₜ is below the predefined threshold is further better understood by way of following pseudo code provided as:

```
Data: Dₜₑₛₜ ; Model: M
Initialize: x_{ref} ∈ Dₜₑₛₜ
Dₜₑₛₜ − x_{ref} : xᵢ → i = random(N)
Xᵢ = xᵢ + perturb(xᵢ)
for i = 1 → N do
  drift = compute_drift(x_{ref},xᵢ)
  driftₘₑₐₙ = fit(drift)
  uq = compute_uq(yᵢ,predict(model,xᵢ))
  mperf = compute_mperf(xᵢ,yᵢ)
end
Store : Correlation Table (T : drift_mean,uq,mperf)
Input: xᵥₐₗ
while True do
  drift_meanᵥₐₗ = compute_drift (x_{ref},fit(xᵥₐₗ))
  for k in T do
    (|drift_meanᵥₐₗ − driftₖ|)
  end
  kₘᵢₙ = k: → min(|drift_meanᵥₐₗ − driftₖ|)
  (mperf,uq)ₚ :→ p = kₘᵢₙ,kₘᵢₙ₋₁,kₘᵢₙ₊₁
  (mperf)_{best} = (mperf)ₚ :→ min(uqₚ)
end
if |(mperf)_{best} − (mperf)ᵥₐₗ| > δ then
  return (mperf)_{best}
  Raise trigger
end
```

In an embodiment, mathematical framework of the present disclosure is explained by way of the following exemplary explanation.

The mathematical formulation of the present disclosure is based on Fast Hoeffding Drift Detection method (FHDDM) which relies on Hoeffding Inequality. This can be used to detect any deviation between expected and observed model performance caused due to drift.

### Mathematical Formulation:

If X̅ denotes a measure of a random variable X at a given instance, and E [X] denotes expectation value of X, then a probability that deviation between the two quantities exceeds a predefined threshold is provide in equation (2) below as:

P(|X̅−E[X]|≥ϵ)≤α, (2)

Where, ϵ is provided in equation (3) below:

$$ϵ = \sqrt{\frac{1}{2 n} ln \frac{2}{α}} \qquad ( 3 )$$

In the present disclosure, the probability that deviation between the two quantities exceeds a predefined threshold is provided as shown in equation (4) below:

P(|f_{θ}(Xᵢ)−E[f_{θ}(Xᵢ)]|≥ϵ_{θ})≤α, ∀i (4)

Here, Xᵢ denotes test data in i^{th} data bucket, Xᵣ denotes reference dataset, θ denotes user supplied trained model, f_{θ}(X,) denotes labels predicted by the model for Xᵢ, E[f_{θ}(Xᵢ)] denotes true labels corresponding to Xᵢ, ϵ_{θ} denotes maximum deviation of the model predictions and true labels for a given model θ, n denotes sample size in each data bucket, and a denotes significance level.

### Empirical Reasoning:

For a given choice of significance level i.e., α and a given sample size i.e., n, deviations between an observed and an expected model performance caused due to variation in confidence levels is estimated. In the present disclosure, the sample size is fixed to be 40 and a list of the different deviations between the observed and the expected model performance caused due to variation in confidence levels is listed. Table 2 and Table 3 provides a list of empirical observations. Table 2 shows the variation of the error bounds with the confidence interval for credit card fraud detection dataset with sample size 5000.

TABLE 2
Sample size: 5000 (Credit card fraud detection)

| α | Probability (%) | Confidence level | ∈(%) |
|---|---|---|---|
| 0.01 | 99 | 3σ | 2.30 |
| 0.05 | 95 | 2σ | 1.92 |
| 0.32 | 68 | 1σ | 1.49 |

Similarly, Table 3 shows the variation of the error bounds with the confidence interval for loan predict dataset with sample size 40.

TABLE 3
Sample size: 40 (Loan Predict)

| α | Probability (%) | Confidence level | ∈(%) |
|---|---|---|---|
| 0.01 | 99 | 3σ | 25 |
| 0.05 | 95 | 2σ | 21.47 |
| 0.32 | 68 | 1σ | 16.60 |

It is observed form Table 2 and Table 3 that for a given sample size, with low deviation between the expected and the observed model performance the confidence level increases and hence the model uncertainty associated with the model decreases because the model is more prone to predict what is expected. Hence, the model accuracy having the lowest model uncertainty or high confidence is selected. From the empirical observations listed in Table 2 and Table 3, it is inferred that as the model confidence increases, thereby leading to decrease in uncertainty associated with the model, the maximum probability that the model prediction deviates from the true labels decreases increases and corresponding deviation between the predicted and actual label also decreases. From the above empirical observation in Tables 2, 3 and equation (4), the following Lemma as provide in equation (5) below is formulated, which states that: Lemma 1 With decreasing model confidence and increasing model uncertainty (σ), the maximum error bound (ϵ) increases linearly with the slope dependent on the sample size and significance level.

ϵ_{θ}(n, α)˜g_{θ}(n, α)σ+h_{θ}(n, α) (5)

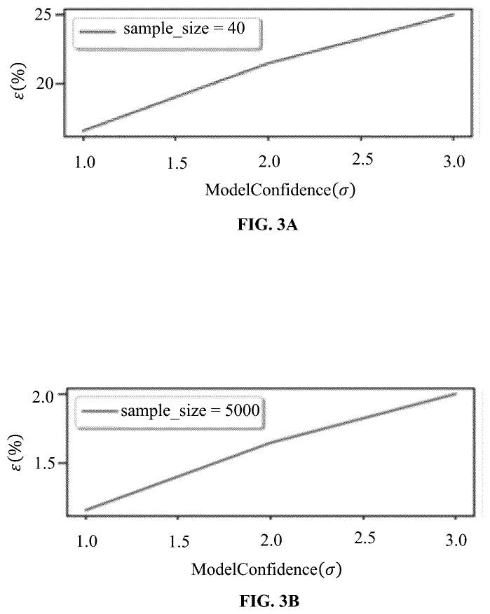

g_{θ}(n, α), h_{θ}(n, α) denote slope and intercept of the ϵ−σ variation respectively. The value of the slope and intercept parameter depends on the sample size of specific case under consideration, and significance level of choice. Nevertheless, the linear trend holds up. FIGS. 3A and 3B depict graphical representations to illustrate variation of error bound with model confidence for the sample size 40 and 5000 respectively, in accordance with an embodiment of the present disclosure.

### Experimental Results:

In the present disclosure, goal of experiments was to estimate the deviation in the ML model performance from the true labels for a user defined dataset using the drift distribution of the new dataset and the model uncertainty. The experiments are carried out on both tabular data and image data. The present discourse describes experimental details and the results of the conducted experiments on different type of data below:

### Experimental Details

In the present disclosure, the different type of data on which the experiments are conducted include loan predict data, credit card fraud detection, balanced prediction data and MNIST data. Experimental details are summarized in Table 4 provided below as:

TABLE 4

| | | | | Performance |
|---|---|---|---|---|
| Case Study | Data | Type | Model | metric |
| Loan Predict | Tabular | Classification | Random | Accuracy |
| Credit card | Tabular | Classification | Forest | Average |
| fraud detection | | | XGBoost | Precession |
| MNIST | Image | Classification | | Accuracy |
| Balance | Tabular | Regression | CNN | Mean |
| prediction | | | Random | Squared Error |
| | | | Forest | |

For loan predict data, there were 12 attributes out of which 5 are categorical and the rest are numerical. The label is represented by two classes. Further, the ML model was trained using Random Forest Classifier with the hyperparameters n_estimators=10, max_depth=3, min_samples_leaf=3. The hyperparameters were chosen via GridSearchCV. Since the loan predict data was more or less balanced with the two classes constituting around 68% and 32% of the entire data, the ML model performance metric was chosen to be Accuracy. Depending on imbalance ratio, a different metric is chosen. Further, 80% of the loan predict data was used for training and rest 20% for testing. The ML model was trained on the training data and used as a reference model. A part of the test data was used as the reference data for drift and model uncertainty computation. The remaining part of the test data is divided into multiple buckets of sample size 5000, distributed randomly. For each bucket, the ML model performance, drift and model uncertainty are computed and stored in a look up table which is used for evaluating the model performance for a given drift.

For credit card fraud detection data, there were 16 input features out of which 5 are categorical columns and rest are numerical columns. The label is represented by two classes. The ML model was trained using XGBoost model with the hyperparameters n_estimators=200, max_depth=11, learning_rate=0.3. The hyperparameters were chosen via RandomizedSearchCV. The actual distribution of the classes in the test data was highly imbalanced. Hence the metric chosen for the credit card fraud detection data was average precession. In the present disclosure, the experiment for multiple imbalance ratios between different classes to account for the robustness. 70% of the credit card fraud detection data was used for training and rest 30% for testing. A part of the test data was used for reference and the remaining part was divided into buckets of samples size 40 to compute the model performance, drift and model uncertainty table. For each bucket, the model performance, drift and model uncertainty are computed and stored in a look up table which is used for evaluating model performance for a given drift.

In the present disclosure, MNIST dataset from tensorflow Keras module is considered. The data in MNIST dataset consisted of 60000 grey scale images of handwritten digits from 0 to 9. The output has 10 classes in total. Further, convolutional neural network (CNN) is used with the convolution layer having filter size(3,3) followed by a max pooling layer and dense layers. During experiments, 70% of the images for training and 30% for testing are used and accuracy is chosen as the metric.

### Results and Observations

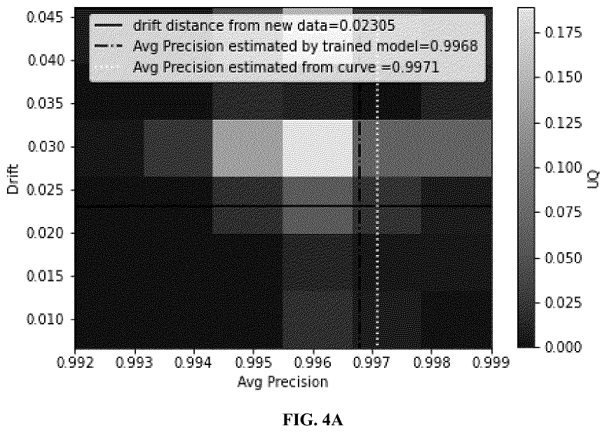

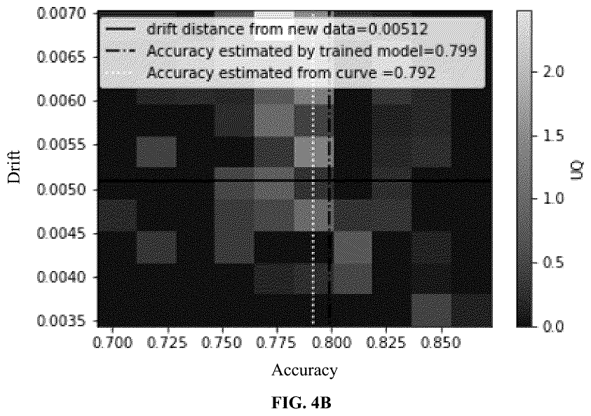

The present disclosure reports results in terms of predicted model performance and actual model performance. FIGS. 4A and 4B depict plots illustrating correlation between drift, model performance and model uncertainty for two different type of sample data, in accordance with an embodiment of the present disclosure. FIG. 4A depict the plot illustrating correlation between drift, model performance and model uncertainty for credit card fraud detection data, in accordance with an embodiment of the present disclosure. FIG. 4B depict the plot illustrating correlation between drift, model performance and model uncertainty for loan predict data, in accordance with an embodiment of the present disclosure. Each cell in the plots represent a distinct bucket containing a subsample of test data. These essentially depicts a geometrical representation of the look up table or correlation table. In FIGS. 4A and 4B, the solid and dotted lines represent the predicted model performance and actual model performance respectively. It is observed that that for all loan predict, fraud detection and MNIST datasets, the predicted model performance and true value lies within the 10% error bars. This explains that model uncertainty based filtering and choice of minimum model uncertainty is robust across the type of dataset. In other words, the different cells represent each bucket and different axis denote the drift, model performance, and third dimension represented by bars denotes the model uncertainty. The different cells were constructed using the correlations computed from drift, model uncertainty, and model performance. The solid line denotes the model performance using the baseline or trained model while the dotted line represents the model performance estimated from the lookup table. It is observed from FIS. 4A and 4B that there can be multiple model performances associated with a given drift. However, the model performance corresponding to lowest model uncertainty is selected as it ensures highest model confidence.

The written description describes the subject matter herein to enable any person skilled in the art to make and use the embodiments. The scope of the subject matter embodiments is defined herein and may include other modifications that occur to those skilled in the art. Such other modifications are intended to be within the scope of the present disclosure if they have similar elements that do not differ from the literal language of the embodiments or if they include equivalent elements with insubstantial differences from the literal language of the embodiments described herein.

Retraining the ML model is computationally expensive and might require additional resources and efforts. The embodiments of present disclosure provide a system and method that estimates the model performance from a given user data, having different distribution from the training data, without having to retrain the model and in line with the mathematical consistencies. In the method of present disclosure, the model performance of an AI model deployed in production is estimated, in absence of ground truths. Moreover, this can be done without retraining the model, thus saving computational costs and resources. The method of the present disclosure can be used and performed in real time.

It is to be understood that the scope of the protection is extended to such a program and in addition to a computer-readable means having a message therein; such computer-readable storage means contain program-code means for implementation of one or more steps of the method, when the program runs on a server or mobile device or any suitable programmable device. The hardware device can be any kind of device which can be programmed including e.g. any kind of computer like a server or a personal computer, or the like, or any combination thereof. The device may also include means which could be e.g. hardware means like e.g. an application-specific integrated circuit (ASIC), a field-programmable gate array (FPGA), or a combination of hardware and software means, e.g. an ASIC and an FPGA, or at least one microprocessor and at least one memory with software processing components located therein. Thus, the means can include both hardware means and software means. The method embodiments described herein could be implemented in hardware and software. The device may also include software means. Alternatively, the embodiments may be implemented on different hardware devices, e.g. using a plurality of CPUs.

The embodiments herein can comprise hardware and software elements. The embodiments that are implemented in software include but are not limited to, firmware, resident software, microcode, etc. The functions performed by various components described herein may be implemented in other components or combinations of other components. For the purposes of this description, a computer-usable or computer readable medium can be any apparatus that can comprise, store, communicate, propagate, or transport the program for use by or in connection with the instruction execution system, apparatus, or device.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope of disclosed embodiments being indicated by the following claims.

What is claimed is:

1. A processor implemented method, comprising:
receiving, via one or more hardware processors, a plurality of test data Dₜₑₛₜ and a model under evaluation M as an input from a user;
computing, via the one or more hardware processors, a drift distribution of the plurality of test data Dₜₑₛₜ using one or more user specified drift computation methods;
comparing, via the one or more hardware processors, a spread in the computed drift distribution of the plurality of test data Dₜₑₛₜ with a predefined threshold;
performing, via the one or more hardware processors, steps (i) through (iii) when the spread in the computed drift distribution of the plurality of test data Dₜₑₛₜ exceeds the predefined threshold:
(i) partitioning, the plurality of test data Dₜₑₛₜ into a first dataset and a second dataset, wherein the second dataset is divided into a plurality of data buckets,
(ii) determining, a first set of model parameters for a plurality of data samples comprised in each data bucket from the plurality of data buckets with respect to the first dataset, wherein the first set of model parameters includes a drift distance, a model uncertainty, and one or more model performance metrics, and
(iii) constructing, a first look up table by identifying a correlation among a plurality of model parameters in the first set of model parameters;
computing, via the one or more hardware processors, a drift distribution of a plurality of incoming test data received from the user;
identifying, via the one or more hardware processors, a drift value cell from the first look up table, corresponding to the computed drift distribution of the plurality of incoming test data, wherein the drift value cell is identified based on (i) a minimum deviation between the computed drift distribution of the plurality of incoming test data and a plurality of pre-stored drift distance values in the first look up table, and (ii) a minimum value of model uncertainty; and
estimating, via the one or more hardware processors, at least one of the one or more model performance metrics corresponding to the identified drift value cell from the first look up table to evaluate an optimal performance of the model under evaluation M.

2. The processor implemented method of claim 1, wherein the model under evaluation M is an artificial intelligence based model or a machine learning based model.

3. The processor implemented method of claim 1, wherein the predefined threshold is configurable.

4. The processor implemented method of claim 1, wherein the one or more model performance metrics comprises of an accuracy, an F1 score, and an average precession.

5. The processor implemented method of claim 1, wherein when the spread in the drift distribution of the plurality of test data Dₜₑₛₜ is below the predefined threshold, the method comprising:
perturbing, the second dataset to obtain a perturbed dataset using noise perturbations, wherein the noise perturbations are sampled from gaussian, uniform or poisson distributions and linearly superposed on top of a plurality of true samples of the second dataset;
determining, a second set of model parameters for a plurality of data samples comprised in each data bucket from a plurality of data buckets of the perturbed dataset with respect to the first dataset, wherein the second set of model parameters include a fitted drift mean, the model uncertainty, and the one or more model performance metrics;
constructing, a second look up table by identifying a correlation among each of the second set of model parameters;
computing, a fitted drift mean distribution of the plurality of incoming test data received from the user;
identifying, a drift value cell from the second look up table corresponding to the computed fitted drift mean distribution of the plurality of incoming test data, wherein the drift value cell is identified based on (i) a minimum deviation between the computed fitted drift mean distribution of the plurality of incoming test data and a plurality of pre-stored fitted drift mean values in the second look up table and (ii) a minimum value of model uncertainty; and
estimating, at least one of the one or more model performance metrics corresponding to the identified drift value cell from the second look up table to evaluate an optimal performance of the model under evaluation M.

6. The processor implemented method of claim 1, wherein the optimal performance of the model under evaluation M is evaluated when the model under evaluation M is deployed in production.

7. A system, comprising:
a memory storing instructions;
one or more communication interfaces; and
one or more hardware processors coupled to the memory via the one or more communication interfaces, wherein the one or more hardware processors are configured by the instructions to:
receive, a plurality of test data Dₜₑₛₜ and a model under evaluation M as an input from a user;
compute, a drift distribution of the plurality of test data Dₜₑₛₜ using one or more user specified drift computation methods;
compare, a spread in the computed drift distribution of the plurality of test data Dₜₑₛₜ with a predefined threshold;
perform, steps (i) through (iii) when the spread in the computed drift distribution of the plurality of test data Dₜₑₛₜ exceeds the predefined threshold:
(i) partitioning, the plurality of test data Dₜₑₛₜ into a first dataset and a second dataset, wherein the second dataset is divided into a plurality of data buckets,
(ii) determining, a first set of model parameters for a plurality of data samples comprised in each data bucket from the plurality of data buckets with respect to the first dataset, wherein the first set of model parameters includes a drift distance, a model uncertainty, and one or more model performance metrics, and
(iii) constructing, a first look up table by identifying a correlation among a plurality of model parameters in the first set of model parameters;
compute, a drift distribution of a plurality of incoming test data received from the user;
identify, a drift value cell from the first look up table corresponding to the computed drift distribution of the plurality of incoming test data, wherein the drift value cell is identified based on (i) a minimum deviation between the computed drift distribution of the plurality of incoming test data and a plurality of pre-stored drift distance values in the first look up table, and (ii) a minimum value of model uncertainty; and
estimate, at least one of the one or more model performance metrics corresponding to the identified drift value cell from the first look up table to evaluate an optimal performance of the model under evaluation M.

8. The system of claim 7, wherein the model under evaluation M is an artificial intelligence based model or a machine learning based model.

9. The system of claim 7, wherein the predefined threshold is configurable.

10. The system of claim 7, wherein the one or more model performance metrics comprises of an accuracy, an F1 score, and an average precession.

11. The system of claim 7, wherein when the spread in the drift distribution of the plurality of test data Dₜₑₛₜ is below the predefined threshold, the method comprising:
perturbing, the second dataset to obtain a perturbed dataset using noise perturbations, wherein the noise perturbations are sampled from gaussian, uniform or poisson distributions and linearly superposed on top of a plurality of true samples of the second dataset;
determining, a second set of model parameters for a plurality of data samples comprised in each data bucket from a plurality of data buckets of the perturbed dataset with respect to the first dataset, wherein the second set of model parameters include a fitted drift mean, the model uncertainty, and the one or more model performance metrics;
constructing, a second look up table by identifying a correlation among each of the second set of model parameters;
computing, a fitted drift mean distribution of the plurality of incoming test data received from the user;
identifying, a drift value cell from the second look up table corresponding to the computed fitted drift mean distribution of the plurality of incoming test data, wherein the drift value cell is identified based on (i) a minimum deviation between the computed fitted drift mean distribution of the plurality of incoming test data and a plurality of pre-stored fitted drift mean values in the second look up table and (ii) a minimum value of model uncertainty; and
estimating, at least one of the one or more model performance metrics corresponding to the identified drift value cell from the second look up table to evaluate an optimal performance of the model under evaluation M.

12. The system of claim 7, wherein the optimal performance of the model under evaluation M is evaluated when the model under evaluation M is deployed in production.

13. One or more non-transitory computer readable mediums comprising one or more instructions which when executed by one or more hardware processors cause:
receiving, a plurality of test data Dₜₑₛₜ and a model under evaluation M as an input from a user;
computing, a drift distribution of the plurality of test data Dₜₑₛₜ using one or more user specified drift computation methods;
comparing, a spread in the computed drift distribution of the plurality of test data Dₜₑₛₜ with a predefined threshold;
performing, via the one or more hardware processors, steps (i) through (iii) when the spread in the computed drift distribution of the plurality of test data Dₜₑₛₜ exceeds the predefined threshold:
(i) partitioning, the plurality of test data Dₜₑₛₜ into a first dataset and a second dataset, wherein the second dataset is divided into a plurality of data buckets,
(ii) determining, a first set of model parameters for a plurality of data samples comprised in each data bucket from the plurality of data buckets with respect to the first dataset, wherein the first set of model parameters includes a drift distance, a model uncertainty, and one or more model performance metrics, and
(iii) constructing, a first look up table by identifying a correlation among a plurality of model parameters in the first set of model parameters;
computing, a drift distribution of a plurality of incoming test data received from the user;
identifying, a drift value cell from the first look up table, corresponding to the computed drift distribution of the plurality of incoming test data, wherein the drift value cell is identified based on (i) a minimum deviation between the computed drift distribution of the plurality of incoming test data and a plurality of pre-stored drift distance values in the first look up table, and (ii) a minimum value of model uncertainty; and
estimating, at least one of the one or more model performance metrics corresponding to the identified drift value cell from the first look up table to evaluate an optimal performance of the model under evaluation M.
